(19) United States
(12) Patent Application Publication
(10) Pub. No.: US 2019/0029002 A1
(43) Pub. Date: Jan. 24, 2019

(54) INTELLIGENT VEHICLE-BASED COMMUNICATION MANGEMENT

(71) Applicant: GM Global Technology Operations LLC, Detroit, MI (US)

(72) Inventors: Igal Kotzer, Tel-Aviv (IL); Claudia V. Goldman-Shenhar, Mevasseret Zion (IL); Eilon Riess, Zikron-Yaakov (IL)

(21) Appl. No.: 15/652,756

(22) Filed: Jul. 18, 2017

(51) Int. Cl. H04W 72/04; H04L 29/08

(52) U.S. Cl. CPC H04W 72/04; H04W 4/008; H04L 67/12

(57) ABSTRACT

A system and method to perform intelligent communication management in a vehicle include receiving one or more messages for transmission from the vehicle, and receiving inputs additional to the one or more messages for transmission. A communication manager selects one or more radio access technology (RAT) channels from available RAT channels of the vehicle to respectively transmit the one or more messages. The available RAT channels include a cellular RAT channel, WiFi RAT channel, designated short-range communication (DSRC) RAT channel, or WiGig RAT channel.

### INTRODUCTION

The subject disclosure relates to intelligent vehicle-based communication management.

A vehicle (e.g., automobile, construction equipment, farm equipment, automated factory equipment) may send and receive messages via communications that are referred to as vehicle-to-everything (V2X) communication. V2X communication includes vehicle-to-vehicle (V2V) and vehicle-to-infrastructure (V2I) communication, for example. A vehicle may include multiple radio access technologies (RATs) such as those that provide access to WiFi, a type of WiFi referred to as WiGig, cellular, Bluetooth, or designated short range communication (DSRC). Multiple cellular RATs may be available (e.g., fourth generation long term evolution (4G LTE), fifth generation millimeter wave (5G mmWave)) and more than one Bluetooth client may be supported simultaneously. Typically, a given type of V2X message is associated with a given RAT. In certain circumstances, penetration rate and coverage may be improved by using atypical communication channels that are not originally associated with a given type of communication. Accordingly, it is desirable to provide intelligent vehicle-based communication management.

### SUMMARY

In one exemplary embodiment, a method of performing intelligent communication management in a vehicle includes receiving one or more messages for transmission from the vehicle, and receiving inputs additional to the one or more messages for transmission. One or more radio access technology (RAT) channels are selected from available RAT channels of the vehicle to respectively transmit the one or more messages. The available RAT channels include a cellular RAT channel, WiFi RAT channel, designated short-range communication (DSRC) RAT channel, or WiGig RAT channel.

In addition to one or more of the features described herein, the receiving the inputs includes receiving information about a source of each of the one or more messages.

In addition to one or more of the features described herein, the receiving the information about the source includes receiving information about a vehicle system of the vehicle or a Bluetooth-enabled user device.

In addition to one or more of the features described herein, the receiving the inputs includes receiving information about the available RAT channels of the vehicle, the information about the available RAT channels including usage and cost information.

In addition to one or more of the features described herein, the receiving the inputs includes receiving context information.

In addition to one or more of the features described herein, the receiving the context information includes receiving information about weather, road type, traffic, or occupancy of the vehicle.

In addition to one or more of the features described herein, the receiving information about the traffic includes receiving information indicating a presence of pedestrians with cellular devices.

In addition to one or more of the features described herein, the receiving the inputs includes receiving information about a user of a vehicle system or a Bluetooth-enabled user device that is a source of each respective one of the one or more messages.

In addition to one or more of the features described herein, the selecting the one or more RAT channels includes minimizing a unified cost associated with transmitting the one or more messages.

In addition to one or more of the features described herein, a time for transmission of the one or more messages by the one or more RAT channels is selected.

In another exemplary embodiment, an intelligent communication management system in a vehicle includes radio access technology (RAT) channels available to transmit from the vehicle. The available RAT channels include a cellular RAT channel, WiFi RAT channel, designated short-range communication (DSRC) RAT channel, or WiGig RAT channel. The intelligent communication management system also includes a communication manager to receive inputs additional to one or more messages for transmission and select one or more of the available RAT channels of the vehicle to respectively transmit the one or more messages.

In addition to one or more of the features described herein, the inputs include information about a source of each of the one or more messages.

In addition to one or more of the features described herein, the source includes a vehicle system of the vehicle or a Bluetooth-enabled user device.

In addition to one or more of the features described herein, the inputs include information about the available RAT channels of the vehicle, the information about the available RAT channels including usage and cost information.

In addition to one or more of the features described herein, the inputs include context information.

In addition to one or more of the features described herein, the context information includes weather, road type, traffic, or occupancy of the vehicle.

In addition to one or more of the features described herein, the information about the traffic includes information indicating a presence of pedestrians with cellular devices.

In addition to one or more of the features described herein, the inputs include information about a user of a vehicle system or a Bluetooth-enabled user device that is a source of each respective one of the one or more messages.

In addition to one or more of the features described herein, the communication manager is configured to select the one or more RAT channels based on minimizing a unified cost associated with transmitting the one or more messages.

In addition to one or more of the features described herein, the communication manager is additionally configured to select a time for transmission of the one or more messages by the one or more RAT channels.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of the intelligent VMC-based communication system in a vehicle according to one or more embodiments; and

FIG. 2 shows a process flow of a method of performing intelligent vehicle-based communication management according to one or more embodiments.

### DETAILED DESCRIPTION

The following description is merely exemplary in nature and is not intended to limit the present disclosure, its application or uses.

As previously noted, a vehicle may communicate with a plurality of external entities (e.g., vehicles, infrastructure) via V2X communication. Exemplary vehicle services that perform V2X communication include the infotainment system, which receives streaming video, radio, and other communication, the software upgrade application, and the autonomous driving system, which may rely on communication from sensors or infrastructure outside the vehicle. As also noted, each type of V2X communication has typically been associated with a type of RAT (e.g., device providing access to WiFi, WiGig, cellular, DSRC communication).

However, there may be a variety of reasons to use a different RAT for a particular type of communication than the one generally associated with the type of communication. For example, redundancy may be required to increase coverage in certain situations (e.g., typically used cellular communication is not available). As other example, the typically used RAT (e.g., cellular RAT for V2V communication or DSRC RAT for communication with a pedestrian) may experience a network overload, or a new version of a RAT may not be backwards compatible. Information about the particular application being used by a vehicle occupant may also indicate a more optimal RAT or redundant RAT in certain situations. For example, long latencies may be less desirable for a rear-seat occupant streaming a movie or a driver obtaining driving instructions such that urgency of the communication may affect the RAT that is used. Embodiments of the systems and methods detailed herein relate to intelligent vehicle-based communication management. Specifically, an intelligent V2X multi-RAT communication (VMC) manager is used to determine one or more RAT channels to use for each message to be sent from the vehicle. A different RAT than is usually used may also be used to receive data for a given application. For example, a cellular RAT (e.g., 4G, 5G) may be used to receive V2X communication or an update may be received via a WiFi RAT. More than one RAT (e.g., both 4G and 5G) may be used concurrently to achieve a target of cost, latency, speed, and additional factors for a data session.

While the vehicle application is specifically discussed for explanatory purposes, embodiments discussed herein may be extended to select one or more mobile devices among an available set. For example, different protocols, costs, and dynamic loads may be associated with communications among devices in the internet of things (IoT) ecosystem. A communication manager, according to embodiments detailed herein, may determine a particular protocol, for example, to reduce communication cost or achieve another goal.

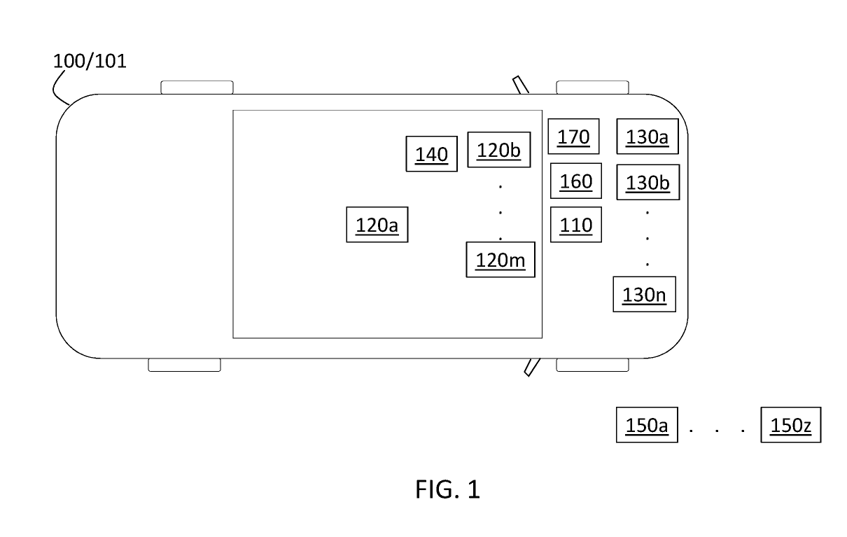

In accordance with an exemplary embodiment, FIG. 1 is a block diagram of the intelligent VMC-based communication system in a vehicle 100. The vehicle 100 is an automobile 101 in the exemplary case. The VMC 110 is an artificial intelligence system trained by any known algorithm. The VMC 110 may be implemented as a multi variable cost function. Cost parameters may include monetary cost, throughput, latency, level of urgency, and driver state, for example. For each application, a weighting may be applied to the various factors in the cost function. Depending on the parameter state at any given time (e.g., availability of network, available throughput for networks, vehicle and surrounding state), an algorithm selects the one or more RATs that minimize the overall cost. Based on the above-described or other known algorithm, the VMC 110 selects one or more RAT channels 130a through 130n (generally referred to as 130) to communicate messages from one or more vehicle systems 120a through 120m (generally referred to as 120) to devices 150a through 150z (generally 150) that are outside the vehicle 100.

One or more devices 140 (e.g., Bluetooth enabled devices) currently in the vehicle 100 are also determined by the VMC 110, because these may be the sources of the messages to be transmitted. A controller 160, which may represent a number of separate systems, may provide information to the VMC 110 that indicates context. For example, the controller 160 may provide information about weather or the number of occupants in the vehicle 100. The controller 160 may incorporate or be in communication with sensors 170 (e.g., camera, radar, lidar) of the vehicle 110 that detect objects around the vehicle 110 and can indicate the presence of pedestrians and other vehicles, for example.

The RAT channels 130 are associated with different RATs that may provide access to WiFi, WiGig, cellular, DSRC, Bluetooth, or other communication systems. The vehicle systems 120 may include the infotainment system, safety systems that communicate hazards via V2V, V2I, or other messages, the navigation system, autonomous driving system 120, or any other system that entails communication. The devices 150 outside the vehicle 100 may include pedestrians, mobile devices, infrastructure, or other vehicles, for example.

One example of VMC 110 operation involves software updates to the infotainment vehicle system 120 or the navigation vehicle system 120 of the vehicle 100. The infotainment vehicle system 120 communicates selection information by an occupant of the vehicle 100 and streams video to one or more display devices in the vehicle 100, for example. The navigation vehicle system 120 communicates location information and displays directions to the driver of the vehicle 100. Typically, the software updates for these and other vehicle systems 120 are done through a cellular RAT channel 130 using a subscription-based cellular service. According to exemplary embodiments, the VMC 110 may determine that a WiFi RAT channel 130 should be used for the software updates. The determination may be based on the update not being indicated as a critical update, for example. Thus, according to the present example, cost may be a factor considered by the VMC 110 to select the channel 130, because the WiFi RAT channel 130 is free.

Another example of VMC 110 operation involves safety messages. In a low-visibility urban scenario, for example, safety vehicle systems 120 of the vehicle 100 issue informational messages. For example, a braking event by the vehicle 100 may generate a V2V message broadcast to nearby vehicles 100. Typically, informational messages are transmitted via a DSRC RAT channel 130. According to exemplary embodiments, the VMC 110 determines the context of the scenario. If, for example, the context of the vicinity of the vehicle 100 includes heavy pedestrian traffic, the V2V DSRC messages are insufficient to warn pedestrians. The VMC 110 may determine that a WiFi RAT channel 130 or long term evolution (LTE) RAT channel 130 should alternatively or additionally be used to transmit the safety messages.

According to the present example, the VMC 110 may use multiple factors to make the determination of which one or more RAT channels 130 to use. For example, the VMC 110 may consider the existing RAT channel 130 usage for other communication. Thus, if 70 percent of messages use the DSRC RAT channel 130 and 30 percent of messages use the LTE RAT channel 130, the LTE RAT channel 130 has less traffic and may be selected by the VMC 110. As another or additional example, the VMC 110 may use information from the controller 160, based on the sensors 170, that indicates whether other vehicles 100 or pedestrians are in the vicinity and whether the environment is generally urban, suburban, rural, or a highway with relatively fast-moving vehicles 100.

Additional examples indicate the need for the VMC 110 to balance two or more factors in determining the one or more RAT channels 130 for use. The VMC 110 may balance quality and speed requirements, for example. The VMC 110 may use information about the vehicle system 120 being used or context information to determine the level of urgency (i.e., requirement for low latency) in comparison to the need for accuracy (i.e., requirement for low error rate). If the driver uses voice commands in the vehicle navigation system 120, the speech recognition processing in a cloud-based system may be relatively more efficient but may result in relatively longer latency than another processor accessed by another RAT channel 130. The VMC 110 may use the RAT channel 130 associated with lowest latency in this case. On the other hand, when the vehicle system 120 is the vehicle autonomous driving system 120, low latency and accuracy may be deemed as equally important. The VMC 110 may select the available RAT channel 130 associated with the least current usage for transmission of each message generated by the vehicle autonomous driving system 120.

For messages that can tolerate a delay, the VMC 110 may schedule transmission based on connection quality of a RAT channel 130 along a route and cost associated with each RAT channel 130. For example, the vehicle 100 may send a monthly status report to a maintenance facility in a V2I message. Because there is no particular time that this message must be sent, the VMC 110 can forego sending the message via a cellular RAT channel 130 and, instead, delay the message until the vehicle 100 has access to a free WiFi RAT channel 130 (e.g., when the vehicle 100 is parked at the driver's home).

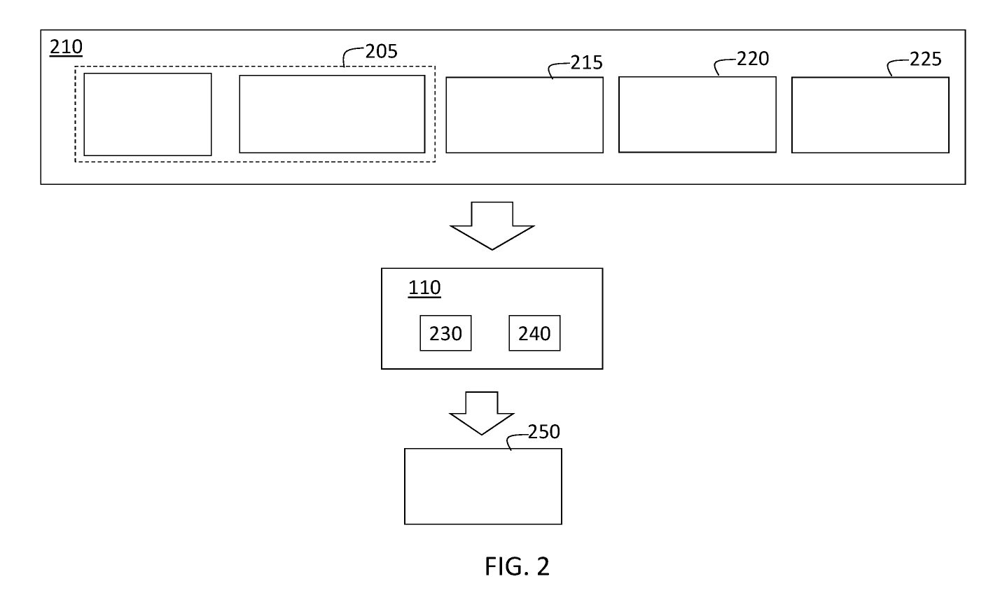

FIG. 2 shows a process flow of a method of performing intelligent vehicle-based communication management according to one or more embodiments. Specifically, FIG. 2 indicates the processes by which the VMC 110 selects (at block 250) one or more RAT channels 130 for communication of one or more messages from one or more vehicle systems 120 at a given time. The VMC 110 determines the time of transmission in addition to the RAT channel 130 for the transmission and may delay some transmission until a RAT channel 130 (e.g., lower cost RAT channel 130) is available.

The VMC 110 includes processing circuitry that may include an application specific integrated circuit (ASIC), an electronic circuit, a processor 230 (shared, dedicated, or group) and memory 240 that executes one or more software or firmware programs, as shown in the embodiment of FIG. 2, a combinational logic circuit, and/or other suitable components that provide the described functionality.

Block 210 indicates inputs received by the VMC 110 that may be factors that are considered by the VMC 110 in selecting one or more RAT channels 130, at block 250. The input at block 210 is obtained at a time t when a message M or set of messages M₁, . . . , Mx is generated for transmission from the vehicle 100. Inputs include information about the source of the message M or sources of a set of messages M₁, . . . , Mx, at block 205. The sources may be a currently enabled device 140 (i.e., at time t) or one or more vehicle systems 120. At block 215, information indicates currently available RAT channels 130 and additional information about the available RAT channels 130 such as, for example, percentage of available or occupied bandwidth of each. Specific cost information associated with one or more RAT channels 130 (e.g., that WiFi RAT channel 130 is free, rate of cellular RAT channel 130) may also be provided. This information facilitates a determination of the cost (e.g., monetary, data) of each RAT channel 130.

Another input, at block 210, includes information about the context of the drive (e.g., weather, road type, traffic, occupancy of vehicle 100), at block 220. User information, at block 225, includes user preferences and other information about the user. As an example, driver or passenger attentiveness may be determined and used, by the VMC 110, to select the appropriate RAT channel 130. Systems that track user behavior such as cameras or eye-tracking systems within the vehicle 100 may provide input directly to the VMC 110 or may be used to generate a user model that is provided to the VMC 110. That is, the user information at block 225 may be from a user model rather than directly from systems tracking user behavior. When the VMC 110 determines, based on the systems or the model, that user attentiveness is low, the VMC 110 may select the RAT channel 130 accordingly. For example, a longer latency (e.g., using a RAT channel 130 with a slower data rate) may be tolerated by a passenger who is in and out of a sleep state while streaming a movie over the infotainment system of the vehicle 100.

When there is one message M for transmission, the VMC 110 prioritizes among the inputs from block 210 based on the particular vehicle system 120 involved. For example, as discussed in the previous examples, when the message is from the vehicle autonomous driving system 120, the VMC 110 selects a RAT channel 130 that minimizes latency and maximizes accuracy. That is, the VMC 110 may prioritize information about the available RAT channels 130 (block 215) to make a determination. For other messages, low latency or low cost may be the highest priority in the selection of the RAT channel 130. When the message is a safety message, the context of the drive (block 220) may be considered a priority by the VMC 110. That is, when the context information indicates the presence of pedestrians, a RAT channel 130 may be selected to reach pedestrians as well as other vehicles 100.

When there are multiple messages M₁, . . . , Mx, the VMC 110 may construct a multi-message cost function to determine the unified cost of the several messages M₁, . . . , Mx according to an exemplary embodiment. For each time between t and t+T, the cost of transmission of each message present at time t may be computed by the VMC 110. The VMC 110 may then search for the solution (RAT channel 130 assignment to each message) with minimal cost. At t+T, the VMC 110 designates all or a subset of the messages M₁, . . . , Mx for transmission such that the unified cost function is lower than a predefined threshold for the time t+T.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of performing intelligent communication management in a vehicle, the method comprising:
receiving one or more messages for transmission from the vehicle;
receiving inputs additional to the one or more messages for transmission; and
selecting one or more radio access technology (RAT) channels from available RAT channels of the vehicle to respectively transmit the one or more messages, wherein the available RAT channels include a cellular RAT channel, WiFi RAT channel, designated short-range communication (DSRC) RAT channel, or WiGig RAT channel.

2. The method according to claim 1, wherein the receiving the inputs includes receiving information about a source of each of the one or more messages.

3. The method according to claim 2, wherein the receiving the information about the source includes receiving information about a vehicle system of the vehicle or a Bluetooth-enabled user device.

4. The method according to claim 1, wherein the receiving the inputs includes receiving information about the available RAT channels of the vehicle, the information about the available RAT channels including usage and cost information.

5. The method according to claim 1, wherein the receiving the inputs includes receiving context information.

6. The method according to claim 5, wherein the receiving the context information includes receiving information about weather, road type, traffic, or occupancy of the vehicle.

7. The method according to claim 6, wherein the receiving information about the traffic includes receiving information indicating a presence of pedestrians with cellular devices.

8. The method according to claim 1, wherein the receiving the inputs includes receiving information about a user of a vehicle system or a Bluetooth-enabled user device that is a source of each respective one of the one or more messages.

9. The method according to claim 1, wherein the selecting the one or more RAT channels includes minimizing a unified cost associated with transmitting the one or more messages.

10. The method according to claim 1, further comprising selecting a time for transmission of the one or more messages by the one or more RAT channels.

11. An intelligent communication management system in a vehicle, the system comprising:
radio access technology (RAT) channels available to transmit from the vehicle, wherein the available RAT channels include a cellular RAT channel, WiFi RAT channel, designated short-range communication (DSRC) RAT channel, or WiGig RAT channel; and
a communication manager configured to receive inputs additional to one or more messages for transmission and select one or more of the available RAT channels of the vehicle to respectively transmit the one or more messages.

12. The system according to claim 11, wherein the inputs include information about a source of each of the one or more messages.

13. The system according to claim 12, wherein the source includes a vehicle system of the vehicle or a Bluetooth-enabled user device.

14. The system according to claim 11, wherein the inputs include information about the available RAT channels of the vehicle, the information about the available RAT channels including usage and cost information.

15. The system according to claim 11, wherein the inputs include context information.

16. The system according to claim 15, wherein the context information includes weather, road type, traffic, or occupancy of the vehicle.

17. The system according to claim 16, wherein the information about the traffic includes information indicating a presence of pedestrians with cellular devices.

18. The system according to claim 11, wherein the inputs include information about a user of a vehicle system or a Bluetooth-enabled user device that is a source of each respective one of the one or more messages.

19. The system according to claim 11, wherein the communication manager is configured to select the one or more RAT channels based on minimizing a unified cost associated with transmitting the one or more messages.

20. The system according to claim 11, wherein the communication manager is additionally configured to select a time for transmission of the one or more messages by the one or more RAT channels.
